(19) United States
(12) Patent Application Publication
(10) Pub. No.: US 2014/0302728 A1
(43) Pub. Date: Oct. 9, 2014

(54) TERMINAL-CRIMPED CABLE

(71) Applicant: YAZAKI CORPORATION, Minato-ku, Tokyo (JP)

(72) Inventor: Fumie Hino, Makinohara-shi (JP)

(73) Assignee: YAZAKI CORPORATION, Minato-ku, Tokyo (JP)

(21) Appl. No.: 14/351,450

(22) PCT Filed: Oct. 18, 2012
(86) PCT No.: PCT/JP2012/006677

§ 371 Date: Apr. 11, 2014

(30) Foreign Application Priority Data
Oct. 21, 2011 (JP) 2011-231413

(51) Int. Cl. H01R 4/18

(52) U.S. Cl. CPC H01R 4/184
USPC 439/877

(57) ABSTRACT

A terminal-crimped cable (1) includes: a cable (2) including a core (3) made of a single conductive wire and a jacket for covering an outer periphery of the core (3) having an end portion exposed from the jacket (5); and a terminal (7) having a first crimp portion (15, 17) crimped to the end portion of the core (3) so that the terminal is conductive with the core. In a state that the end portion of the core (3) exposed from the jacket (5) is heated and softened, the first crimp portion (15, 17) is crimped to the end portion of the core (3).

### TECHNICAL FIELD

The present invention relates to a terminal-crimped cable.

### BACKGROUND ART

As a conventional terminal-crimped cable, there is known one including: a cable including a core made of a plurality of conductive wires and a jacket for covering an outer periphery of the core; and a terminal having a crimp portion. The crimp portion of the terminal is crimped to an end portion of the core exposed from the jacket to thereby make the core and the terminal conductive with each other (refer to PTL 1).

In this conventional terminal-crimped cable, a ductile metal is intervened between the end portion of the core made of the plurality of conductive wires and an inner face of the crimp portion and is crimped, and thereafter the metal is fused on heating. The fused metal enters between the conductive wires of the core and between the core and the crimp portion, thus increasing a contact area and preventing formation of oxide films.

### CITATION LIST

### Patent Literature

[PTL 1]

U.S. Pat. No. 6,334,798 B1

### SUMMARY OF INVENTION

Incidentally, since the conventional terminal-crimped cable described above has such a structure that since the core is made of the plurality of conductive wires, the larger the cross section of the core is, the larger the number of used conductive wires are, thus increasing production cost. Therefore, for reducing production cost, a core made of a single conductive wire is used for a terminal-crimped cable used for a portion not in need of a flexibility.

However, when the crimp portion is to be crimped to the core, unlike the core made of the plurality of conductive wires, the core made of the single conductive wire does not move in the crimp portion, thus making it difficult to disperse a load applied to the core by crimping the crimp portion.

Accordingly, in the crimp portion of the terminal, an environmental change such as high temperature or low temperature caused a creep to a portion especially having a high contact pressure to thereby decrease contact pressure, failing to secure a sufficient contact pressure in the crimp portion, thus causing such a fear as that the contact resistance between the core and the crimp portion might be increased.

It is, therefore, an object of the present invention to provide a terminal-crimped cable capable of suppressing increase of a contact resistance between a core made of a single conductive wire provided at a cable and a crimp portion provided at a terminal by suppressing decrease of a contact pressure between the core and the crimp portion.

A terminal-crimped cable according to a first aspect of the present invention includes: a cable including a core made of a single conductive wire and a jacket for covering an outer periphery of the core having an end portion exposed from the jacket; and a terminal having a first crimp portion crimped to the end portion of the core, so that the terminal is made conductive with the core. In a state that the end portion of the core exposed from the jacket is heated and softened, the first crimp portion is crimped to the end portion of the core.

The crimp portion is crimped to the end portion of the core in the state that the end portion of the core exposed from the jacket is heated and softened. Thus, this can deepen eating by the crimp portion into the end portion of the core which is in a state of being heated and softened.

As a result, the core and the crimp portion can be adhered more tightly to each other, causing an elastic force between the core and the crimp portion, thus enabling to suppress occurrence of the creep to the core made of the single conductive wire. This can suppress decrease of the contact pressure between the core and the crimp portion, thus enabling to suppress increase of the contact resistance between the core and the crimp portion.

The terminal may further include a second crimp portion positioned on the jacket side relative to the first crimp portion. In this case, the second crimp portion is crimped to the jacket.

Since the second crimp portion is crimped to the jacket, it is possible to increase a fixing portion where the terminal is crimped to the cable, thus enabling to stabilize fixing between the terminal and the cable.

The terminal-crimped cable according to the first aspect of the present invention can bring about an effect of suppressing increase of the contact resistance between the core made of the single conductive wire and the crimp portion by suppressing decrease of the contact pressure between the core and the crimp portion.

### BRIEF DESCRIPTION OF DRAWINGS

[FIG. 1]

FIG. 1 is a perspective view illustrating an end portion of a cable in a terminal-crimped cable according to a first embodiment.

[FIG. 2]

FIG. 2 is a perspective view before a terminal is crimped to the cable in the terminal-crimped cable according to the first embodiment.

[FIG. 3]

FIG. 3 is a perspective view when the terminal is crimped to the cable in the terminal-crimped cable according to the first embodiment.

[FIG. 4]

FIG. 4 is a cross sectional view of the terminal-crimped cable according to the first embodiment.

[FIG. 5]

FIG. 5 is a perspective view when a terminal is crimped to the cable in a terminal-crimped cable according to a second embodiment.

### DESCRIPTION OF EMBODIMENTS

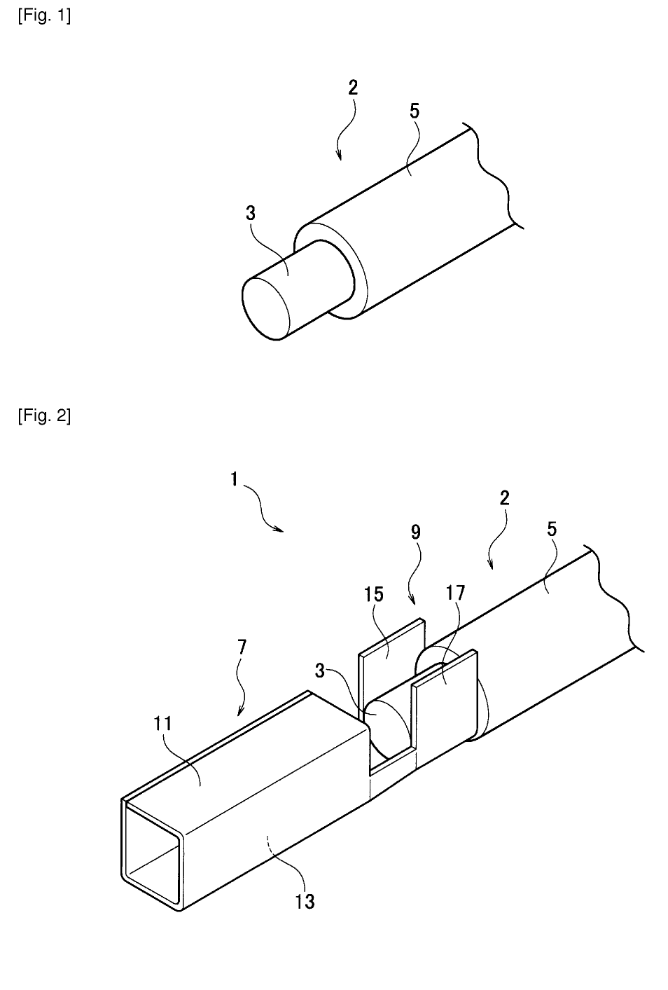

By using FIG. 1 to FIG. 5, a terminal-crimped cable according to embodiments of the present invention will be explained.

### First Embodiment

By using FIG. 1 to FIG. 4, a terminal-crimped cable 1 according to a first embodiment will be explained.

The terminal-crimped cable 1 according to the first embodiment includes: a cable 2 including a core 3 made of a single conductive wire and a jacket 5 for covering an outer periphery of the core 3 having an end portion exposed from the jacket; and a terminal 7 having a crimp portion 9. The crimp portion 9 of the terminal 7 is crimped to the end portion of the core 3 exposed from the jacket 5, so that the terminal 7 is made conductive with the core 3.

Then, in a state that the end portion of the core 3 exposed from the jacket 5 is heated and softened, the crimp portion 9 is crimped to the end portion of the core 3.

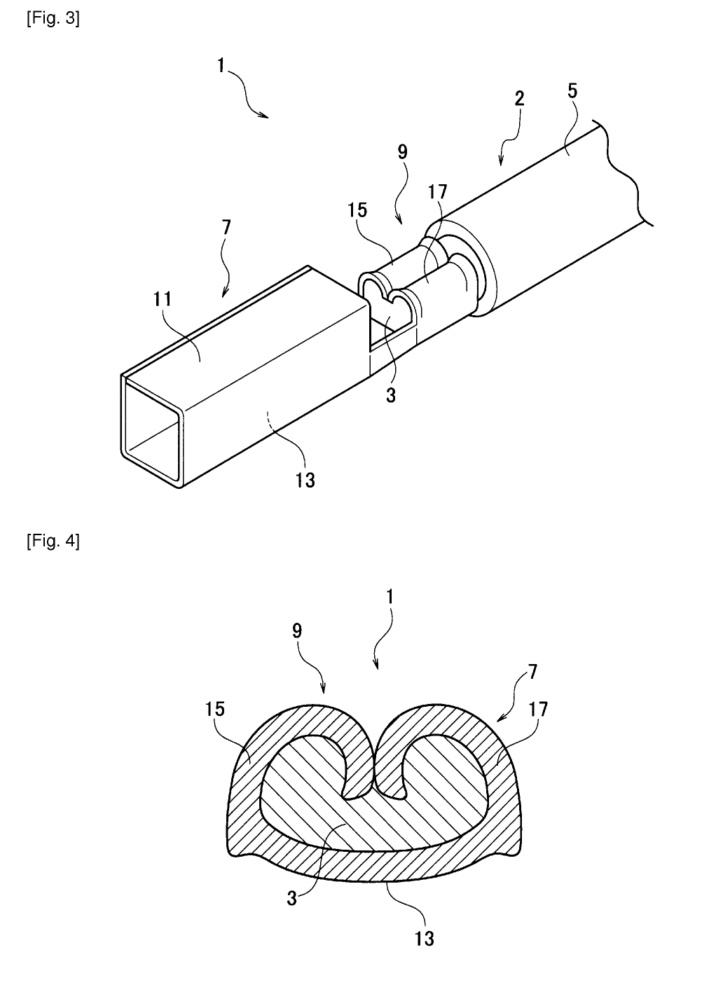

As illustrated in FIGS. 2 and 3, the terminal 7 made conductive with the cable 2 includes a contact portion 11 and the crimp portion 9. The contact portion 11 is made of a female receptacle. When a tab of a male terminal (not illustrated) as a mating terminal is inserted into the contact portion 11, the mating terminal and the terminal 7 are electrically connected. The contact portion 11 is integrally provided with the crimp portion 9.

The crimp portion 9 includes a bottom wall 13 and a pair of side walls 15, 17. The bottom wall 13 is formed of one member continuous with the contact portion 11 and extends in a longitudinal direction of the terminal 7. The bottom wall 13 is disposed on a lower face side of the core 3. The side walls 15, 17 are provided on respective sides of the bottom wall 13 in a width direction.

On respective sides of the bottom wall 13 in the width direction, the side walls 15, 17 are formed of one member continuous with the bottom wall 13. The side walls 15, 17 are crimped by a jig (not illustrated) or the like with an end portion of the core 3 exposed by stripping off the jacket 5, thus electrically connecting the terminal 7 with the core 3.

As illustrated in FIGS. 1 to 4, the cable 2 includes the core 3 and the jacket 5. The core 3 is made of the single conductive wire which is made of a conductive material such as aluminum, aluminum alloy, or the like. The jacket 5 covers an outer periphery of the core 3.

The jacket 5 is made of an insulating material such as synthetic resin and covers the outer periphery of the core 3. Stripping off the jacket 5 at the end portion of the cable 2 exposes the end portion of the core 3, and the crimp portion 9 of the terminal 7 is crimped to the exposed end portion of the core 3.

The end portion of the core 3 is heated and softened before the crimp portion 9 is crimped. The side walls 15, 17 are crimped to the end portion of the core 3 which is in a state of being heated and softened. Thus, an end portion of each of the side walls 15, 17 can eat into a deeper position of the end portion of the core 3 which is in the state of being heated and softened. Further, an inner face of each of the side walls 15, 17 is further adhered to an outer peripheral face of the end portion of the core 3 which is in the state of being heated and softened.

As stated above, crimping the crimp portion 9 to the end portion of the core 3 which is in the state of being heated and softened increases adhesion between the end portion of the core 3 and the crimp portion 9, thus causing an elastic force between the end portion of the core 3 and the crimp portion 9. The elastic force can suppress occurrence of creep (which may be caused by environmental change) of the crimp portion 9 crimped to the core 3, thus enabling to suppress decrease of the contact pressure between the core 3 and the crimp portion 9.

As a production method of the terminal-crimped cable 1 having the above structure, first, the jacket 5 at the end portion of the cable 2 is stripped off, thus exposing the end portion of the core 3. Next, the exposed end portion of the core 3 is heated and softened. Next, the side walls 15, 17 are crimped by the jig or the like to the end portion of the core 3 which is in the state of being heated and softened, thus allowing the terminal 7 to be conductive with the core 3.

As another production method of the terminal-crimped cable 1, first, an end portion of a bare core 3 not covered with the jacket 5 is heated and softened. Next, the side walls 15, 17 are crimped to the end portion of the core 3 which is in the state of being heated and softened. Herein, with respect to another end portion of the cable 2 as well, another terminal 7 may be crimped to the another end portion of the core 3 which is in the state of being heated and softened. This can make a structure that the terminals 7 are crimped to both end portions of the core 3, respectively. Then, after the terminal 7 is crimped to the core 3, the core 3 is covered with the jacket 5. According to the other production method of the terminal-crimped cable 1, compared with the method of stripping off the jacket 5 and thereafter heating and softening the core 3, the core 3 in the original state is not covered with the jacket 5, thus enabling to prevent such an accident as that the jacket 5 is melted in the heating of the end portion of the core 3.

As set forth above, with the terminal-crimped cable 1 according to the first embodiment, the crimp portion 9 is crimped to the end portion of the core 3 in a state that the end portion of the core 3 exposed from the jacket 5 is heated and softened. This can deepen eating of the crimp portion 9 into the end portion of the core 3 which is in the state of being heated and softened.

As a result, the core 3 and the crimp portion 9 can be adhered more tightly to each other, causing the elastic force between the core 3 and the crimp portion 9, thus enabling to suppress occurrence of the creep to the core 3 made of the single conductive wire. This can suppress decrease of the contact pressure between the core 3 and the crimp portion 9, and suppress increase of the contact resistance between the core 3 and the crimp portion 9.

### Second Embodiment

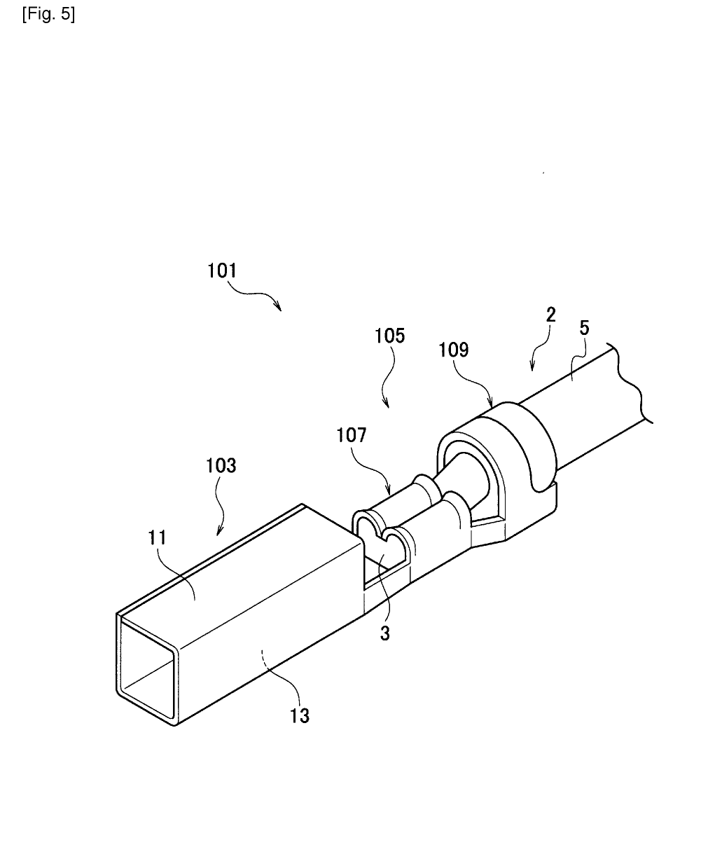

By using FIG. 5, a terminal-crimped cable 101 according to a second embodiment will be explained.

In the terminal-crimped cable 101 according to the second embodiment, the jacket 5 on the core 3 side exposed from the jacket 5 of the cable 2 is also crimped to a crimp portion 105 of a terminal 103. Herein, according to the second embodiment, to similar structural elements as those according to the first embodiment will be added the same reference numerals or signs, and explanations of the structure and function will be omitted as reference can be made to those according to the first embodiment; however, since the terminal-crimped cable 101 according to the second embodiment has the same structure as that according to the first structure, the effect brought about by the second embodiment is similar as that brought about by the first embodiment.

As illustrated in FIG. 5, the crimp portion 105 of the terminal 103 has the bottom wall 13 extending from the core 3 to the jacket 5, and includes a core crimp portion 107 formed of a pair of side walls and a cover crimp portion 109 formed of a pair of side walls. The core crimp portion 107 is formed of one member with the pair of side walls respectively made continuous with the bottom wall 13 on respective sides of the bottom wall 13 in the width direction. By the jig (not illustrated) or the like, the core crimp portion 107 is crimped to the end portion of the core 3 which is in the state of being heated and softened, thus electrically connecting the terminal 103 with the core 3.

The cover crimp portion 109 has the pair of side walls respectively disposed more on the jacket 5 side than the core crimp portion 107 and is formed of one member continuous with the bottom wall 13 on respective sides of the bottom wall 13 in the width direction. The cover crimp portion 109 is crimped to the jacket 5 by the jig (not illustrated) or the like, thus stabilizing fixing between the terminal 103 and the cable 2.

As a production method of the terminal-crimped cable 101 having the above structure, first, the jacket 5 at the end portion of the cable 2 is stripped off, thus exposing the end portion of the core 3. Next, the exposed end portion of the core 3 is heated and softened. Next, the core crimp portion 107 is crimped by the jig or the like to the end portion of the core 3 which is in the state of being heated and softened, and the cover crimp portion 109 is crimped to the jacket 5 by the jig or the like, thus allowing the terminal 103 to be conductive with the core 3 and stabilizing fixing between the terminal 103 and the cable 2.

As set forth above, with the terminal-crimped cable 101 according to the second embodiment, a part of the jacket 5 adjacent to the core 3 exposed from the jacket 5 is crimped to the crimp portion 105 of the terminal 103. Thus, it is possible to increase a fixing portion where the terminal 103 is crimped, by the crimp portion 105, to the cable 2, and to stabilize fixing between the terminal 103 and the cable 2.

Further, in the crimp portion 105 of the terminal 103 according to the second embodiment, the cover crimp portion 109 is so disposed as to be spaced apart from the core crimp portion 107; however, the cover crimp portion 109 may be provided so as to be continuous with the core crimp portion 107.

Further, in each of the terminal-crimped cables according to the first and second embodiments, the contact portion 11 of the terminal crimped to the cable 2 is made of the female receptacle; however, the contact portion 11 may otherwise be a male terminal formed into a tab or the like.

### INDUSTRIAL APPLICABILITY

According to the present invention, it is possible to provide a terminal-crimped cable capable of suppressing increase of a contact resistance between a core made of a single conductive wire provided at a cable and a crimp portion provided at a terminal by suppressing decrease of a contact pressure between the core and the crimp portion.

1. A terminal-crimped cable, comprising:
a cable comprising a core made of a single conductive wire and a jacket for covering an outer periphery of the core having an end portion exposed from the jacket; and
a terminal comprising a first crimp portion crimped to the end portion of the core, so that the terminal is made conductive with the core, wherein
in a state that the end portion of the core exposed from the jacket is heated and softened, the first crimp portion is crimped to the end portion of the core.

2. The terminal-crimped cable according to claim 1, wherein
the terminal further includes a second crimp portion positioned on the jacket side relative to the first crimp portion, and
the second crimp portion is crimped to the jacket.
